(19) United States
(12) Patent Application Publication
(10) Pub. No.: US 2026/0227514 A1
(43) Pub. Date: Aug. 6, 2026

(54) INFORMATION PROCESSING DEVICE, INFORMATION PROCESSING METHOD, AND PROGRAM

(71) Applicant: Sony Group Corporation, Tokyo (JP)

(72) Inventor: Seungha YANG, Kanagawa (JP)

(73) Assignee: Sony Group Corporation, Tokyo (JP)

(21) Appl. No.: 19/152,283

(22) PCT Filed: Feb. 6, 2024
(86) PCT No.: PCT/JP2024/003829

§ 371 Date: Jul. 30, 2025

(30) Foreign Application Priority Data
Mar. 3, 2023 (JP) 2023-032432

(51) Int. Cl. G01S 17/86; G01S 17/89; G06T 7/11; G06T 7/174

(52) U.S. Cl. CPC G01S 17/86; G01S 17/89; G06T 7/11; G06T 7/174

(57) ABSTRACT

Provided is an information processing device including: a scene recognition unit that recognizes a scene of a surrounding environment on a basis of output data from a plurality of LiDARs that sense the surrounding environment at different wavelengths; and a LiDAR selection unit that selects one or a plurality of LiDARs, whose output data is used for semantic segmentation, from among the plurality of LiDARs on a basis of a scene recognition result.

### TECHNICAL FIELD

The present technology relates to an information processing device, an information processing method, and a program.

### BACKGROUND ART

Currently, there are technologies that perform semantic segmentation on the basis of the detection results from LiDARs (light detection and ranging) for, for instance, the purpose of improving the accuracy of automated driving of vehicles. The LiDAR is a sensing technology capable of detecting the distance to a target and the characteristics of the target. In recent years, in addition to sensors such as in-vehicle cameras and millimeter-wave radars, the importance of the LiDAR, which can detect the positions and shapes of targets such as vehicles and pedestrians with high accuracy, has been increasing.

Semantic segmentation is a technology that labels each pixel that constitutes an image with the information indicated by the pixel. The pixels are classified according to categories the pixels belong to, and labeling or category association is performed thereon to indicate what is being reflected. Semantic segmentation can assign to the pixels information about what subjects the pixels constitute.

In order to improve the accuracy of semantic segmentation, a technology has been proposed that performs semantic segmentation by using the detection results from multi-wavelength (fixed two-wavelength) LiDARs so as to classify specific objects (NPL 1).

Furthermore, improving the accuracy of processing on the basis of image scenes is also conceivable. For example, a technology has been proposed that determines a scene on the basis of an image to perform appropriate color conversion and selects a color conversion definition corresponding to the scene (PTL 1).

### CITATION LIST

### Patent Literature

### NPL 1:

A Study on the Effect of Multispectral LiDAR Data on Automated Semantic Segmentation of 3D-Point Clouds (https://www.mdpi.com/2072-4292/14/24/6349)

### PTL 1:

JP 2006-163503A

### SUMMARY

### Technical Problem

In the technology described in NPL 1, plant classification is performed using a LiDAR with a wavelength that targets water. However, in the real world, various objects and substances exist other than plants, and further improvements in classification accuracy have been demanded.

In the technology described in PTL 1, scene determinations are performed on the basis of RGB images. However, further improvements in the accuracy of scene determinations have been demanded to improve the accuracy of semantic segmentation.

The present technology has been made in view of these problems and has an object of providing an information processing device, an information processing method, and a program that can improve the accuracy of semantic segmentation by selecting a LiDAR according to a scene.

### Solution to Problem

In order to solve the above problems, a first technology provides an information processing device including: a scene recognition unit that recognizes a scene of a surrounding environment on a basis of output data from a plurality of LiDARs that sense the surrounding environment at different wavelengths; and
a LiDAR selection unit that selects one or a plurality of LiDARs, whose output data is used for semantic segmentation, from among the plurality of LiDARs on a basis of a scene recognition result.

Furthermore, a second technology provides an information processing method including: recognizing a scene of a surrounding environment on a basis of output data from a plurality of LiDARs that sense the surrounding environment at different wavelengths; and
selecting one or a plurality of LiDARs, whose output data is used for semantic segmentation, from among the plurality of LiDARs on a basis of a scene recognition result.

Moreover, a third technology provides a program causing a computer to perform an information processing method including: recognizing a scene of a surrounding environment on a basis of output data from a plurality of LiDARs that sense the surrounding environment at different wavelengths; and
selecting one or a plurality of LiDARs, whose output data is used for semantic segmentation, from among the plurality of LiDARs on a basis of a scene recognition result.

### BRIEF DESCRIPTION OF DRAWING

FIG. 1 is a block diagram showing the configuration of an information processing system 10 and an information processing device 300.

FIG. 2 is a diagram explaining the outline of the direct Time of Flight.

FIG. 3 is a diagram explaining a LiDAR 100.

FIG. 4 is a diagram explaining a LiDAR 100.

FIG. 5 is a diagram explaining the reason for using LiDARs 100 with different corresponding wavelengths.

FIG. 6 is a diagram explaining the reason for using LiDARs 100 with different corresponding wavelengths.

FIG. 7 is a diagram showing the corresponding wavelengths of the LiDARs 100 according to the present embodiment.

FIG. 8 is a diagram explaining the calibration of the LiDARs 100 and a camera 200.

FIG. 9 is a flowchart showing processing by the information processing device 300.

FIG. 10 is a diagram explaining conversion into an ambient light image.

FIG. 11 is a diagram explaining scene recognition.

### DESCRIPTION OF EMBODIMENTS

An embodiment of the present technology will be described below with reference to the drawings. Note that the description will be given in the following order.
<1. Embodiment>
[1-1. Configuration of Information Processing System 10]
[1-2. Configuration of Information Processing Device 300]
[1-3. Processing by Information Processing Device 300]
<2. Modified Examples>

### 1. Embodiment

### [1-1. Configuration of Information Processing System 10]

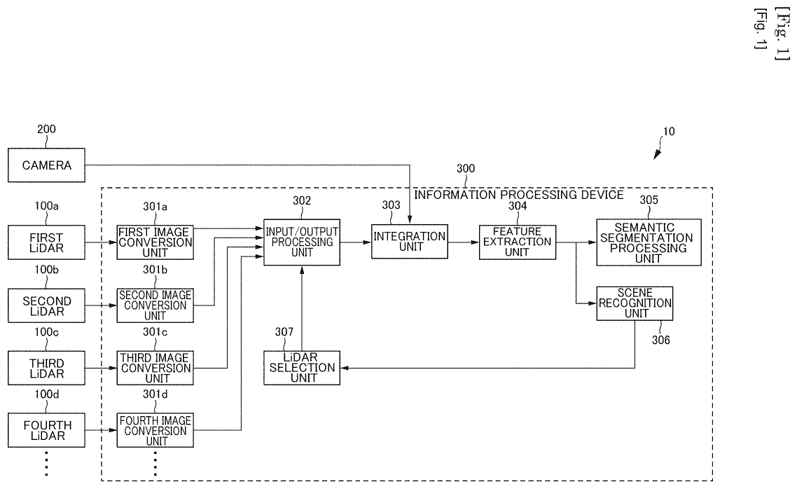

The configuration of an information processing system 10 will be described with reference to FIG. 1. The information processing system 10 is composed of a plurality of LiDARs 100, a camera 200, and an information processing device 300. The plurality of LiDARs 100 and the camera 200 are connected to the information processing device 300.

The LiDARs 100 and the camera 200 may be connected to the information processing device 300 in a wired or wireless fashion. Examples of wired connections include HDMI (Registered Trademark) (High-Definition Multimedia Interface), USB (Universal Serial Bus), and the like, and examples of wireless connections include Wi-Fi, Bluetooth (Registered Trademark), NFC (Near Field Communication), and the like.

In the present embodiment, a first LiDAR 100a, a second LiDAR 100b, a third LiDAR 100c, and a fourth LiDAR 100d are connected to the information processing device 300 as the plurality of LiDARs 100. However, in the present technology, the number of LiDARs 100 is not limited to four and may be any number as long as it is two or more. Note that, in the following description, each of the LiDARs 100 will simply be referred to as the LiDAR 100 when there is no need to distinguish the LiDARs 100.

In the present embodiment, the plurality of LiDARs 100 and the camera 200 are provided as in-vehicle sensors on a vehicle body to sense the surrounding environment of the vehicle. The information processing device 300 operates in the vehicle and selects the LiDAR 100 that is appropriate for semantic segmentation to be used for the vehicle's automated driving from among the plurality of LiDARs 100.

The LiDAR 100 measures the scattered light with respect to the irradiation of laser light that emits light in a pulse shape, and detects the distance to an object or a substance serving as a target (hereinafter referred to as an object or the like), as well as the properties, type, or the like of the object or the like.

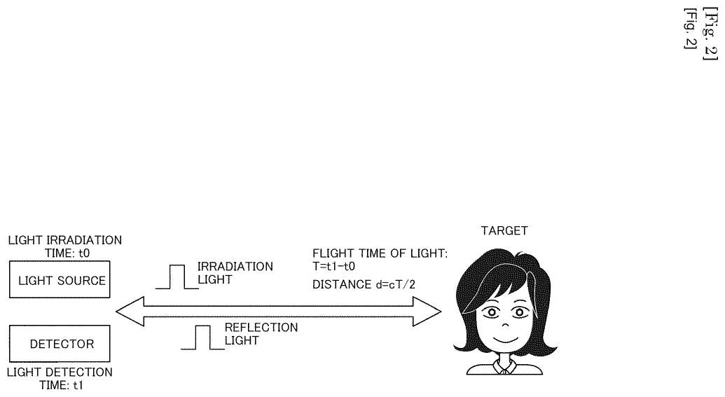

In the present embodiment, the LiDAR 100 includes a distance sensor of the stacked direct Time of Flight (dToF) system using SPAD (Single Photon Avalanche Diode) pixels. The SPAD pixels are used as the light-receiving elements in the dToF system of LiDAR distance measurement systems, which measure the distance by detecting the return time of light (time difference) from a light source to a target as shown in FIG. 2 using a detector.

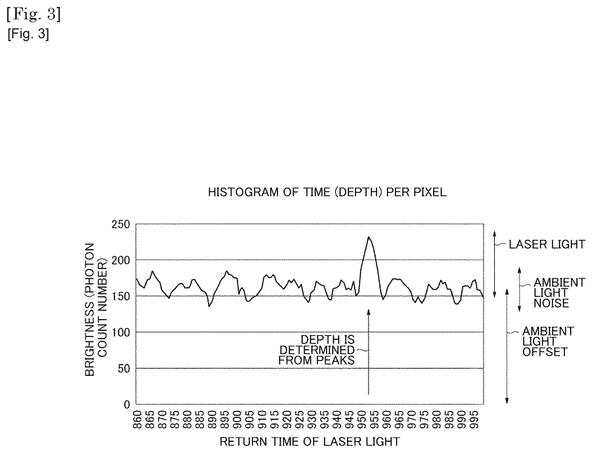

FIG. 3 shows the output data from the LiDAR 100 in a histogram. In the LiDAR 100 using SPAD pixels, depth can be obtained from the peaks in the histogram of time and brightness (photon count number) until the laser light returns for each pixel.

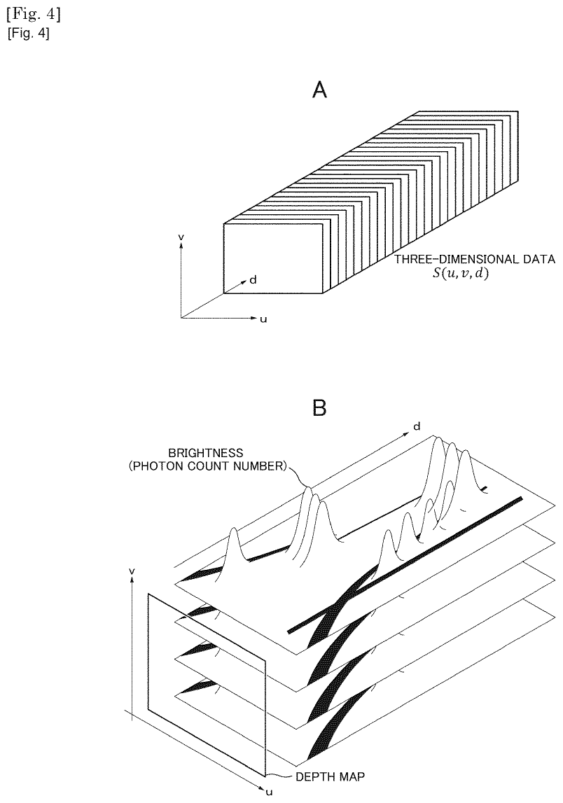

As shown in FIG. 4A, one frame of the output data from the LiDAR 100 has a structure of three-dimensional data represented by S(u, v, d). Furthermore, as shown in FIG. 4B, depth D is represented by the following equation 1 using the three-dimensional data.

$$Depth D ( u , v ) = {arg}_{d} max S ( u , v , d ) \qquad [ Equation 1 ]$$

In the present embodiment, the first LiDAR 100a, the second LiDAR 100b, the third LiDAR 100c, and the fourth LiDAR 100d each have corresponding wavelengths adjusted in advance to sense the surrounding environment at different wavelengths. Currently in order to change the corresponding wavelength relative to the LiDAR, the device itself of the LiDAR must be changed. Accordingly in the present technology the plurality of LiDARs 100 with different corresponding wavelengths are prepared in advance and connected to the information processing device 300 to be capable of handling a plurality of wavelengths.

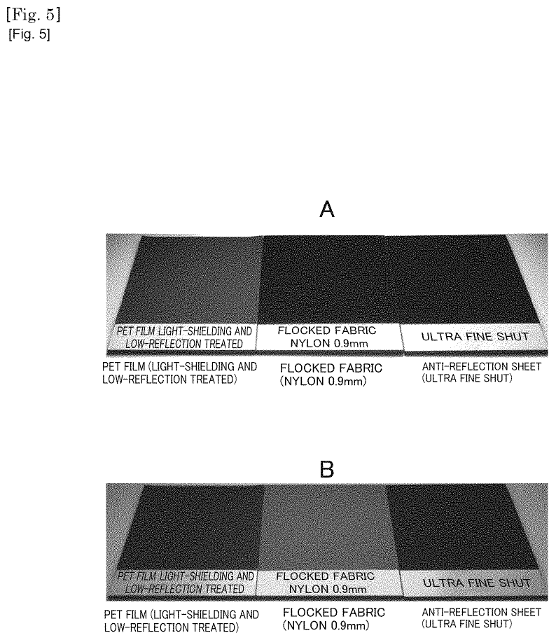

Here, the effect of preparing the plurality of LiDARs 100 with different corresponding wavelengths will be described. As shown in FIG. 5A, an example is given where there are a PET film (light-shielding and low-reflection treated), flocked fabric (nylon 0.9 mm), and an anti-reflection sheet (ultra fine shut). In this case, under visible light with a lower limit wavelength of 360 nm to 400 nm and an upper limit wavelength of 760 nm to 830 nm, the PET film can be distinguished from the flocked fabric and the anti-reflection sheet, but the flocked fabric and the anti-reflection sheet cannot be distinguished from each other.

On the other hand, as shown in FIG. 5B, the flocked fabric and the anti-reflection sheet can be distinguished from each other under near-infrared light with a wavelength of 800 nm to 2500 nm. Thus, it becomes possible to distinguish and detect various objects or the like by using different wavelengths.

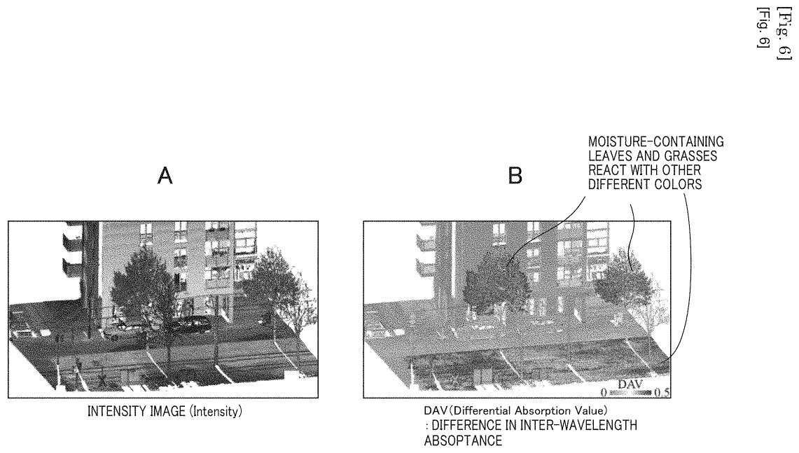

Furthermore, an example is given where the real world is sensed using a two-wavelength LiDAR whose wavelength is adjusted to detect moisture as shown in FIG. 6. FIG. 6A shows an intensity image (Intensity), and FIG. 6B shows a DAV (Differential Absorption Value: a difference in inter-wavelength absorptance).

As shown in FIG. 6B, moisture-containing grasses and leaves react with colors different from those of other objects (such as buildings, roads, and vehicles) and the like that do not contain moisture or contain only a small amount of moisture. This reveals that the grasses and leaves can be distinguished from other objects and the like. Thus, it is possible to distinguish and detect any object and the like by adjusting the wavelength of the LiDAR 100.

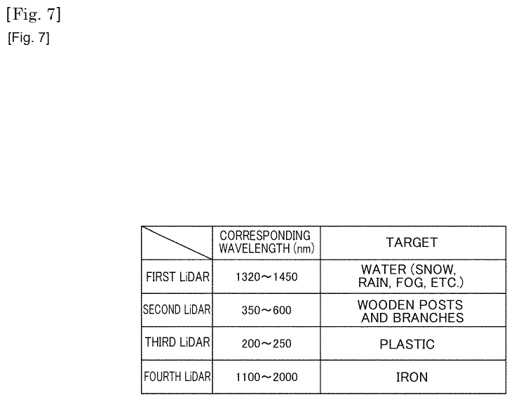

In the present embodiment, the four LiDARs 100 each have their corresponding wavelengths adjusted in advance to correspond to different detection targets as shown in FIG. 7.

The first LiDAR 100a has its corresponding wavelength adjusted to 1320 nm to 1450 nm to target water (such as snow, rain, and fog). Furthermore, the second LiDAR 100b has its corresponding wavelength adjusted to 350 nm to 600 nm to target wooden posts, branches, and the like. Furthermore, the third LiDAR 100c has its corresponding wavelength adjusted to 200 nm to 250 nm to target plastic. Moreover, the fourth LiDAR 100d has its corresponding wavelength adjusted to 1100 nm to 2000 nm to target iron. The targets refer to objects or the like that are sensed by that the LiDAR 100.

Note that the targets shown in FIG. 7 are merely examples, and the present technology is not limited to these targets. Furthermore, the corresponding wavelengths for the respective targets are given as examples and are not necessarily limited to the values shown in FIG. 7. The corresponding wavelengths may be different wavelengths as long as the respective targets can be distinguished and detected.

The camera 200 is a camera that includes a lens, an image sensor, a signal processing circuit, and the like and is capable of capturing camera images (RGB (Red, Green, Blue) images, black-and-white binary images, and the like). The camera 200 is used to capture its surrounding environment and outputs RGB images as camera images to an integration unit 303 in the present embodiment.

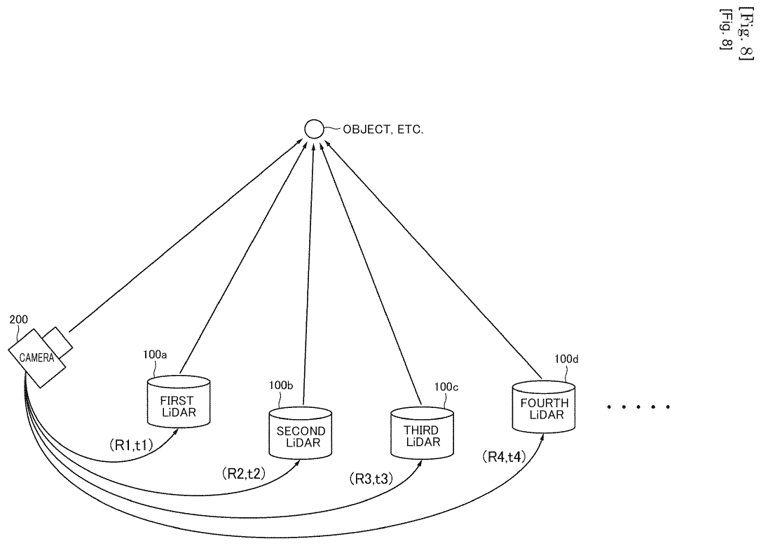

As shown in FIG. 8, the plurality of LiDARs 100 and the camera 200 are calibrated in advance so that the positions of the first LiDAR 100a, the second LiDAR 100b, the third LiDAR 100c, and the fourth LiDAR 100d can be represented as rotation R and translation t with the position of the camera 200 as a reference.

Furthermore, in order to project and integrate RGB images with ambient light images converted from the output data from the plurality of LiDARs 100, the internal parameters (such as a focal length and the center of an optical axis) of the camera 200 are obtained in advance.

### [1-2. Configuration of Information Processing Device 300]

Next, the configuration of the information processing device 300 will be described with reference to FIG. 1. The information processing device 300 includes an image conversion unit 301, an input/output processing unit 302, an integration unit 303, a feature extraction unit 304, a semantic segmentation processing unit 305, a scene recognition unit 306, and a LiDAR selection unit 307.

The image conversion unit 301 converts an intensity image (Intensity) in the output data from the LiDAR 100 into an ambient light image (Ambient) and outputs the converted image to the input/output processing unit 302. The intensity image is an image composed of the peak values of histograms for each pixel. The ambient light image refers to the accumulation of histograms for each pixel and can be converted into an ambient light image by accumulating a plurality of intensity images in the output data from the LiDAR 100.

The information processing device 300 includes a plurality of image conversion units 301 corresponding to the plurality of LiDARs 100, respectively. In the present embodiment, the information processing device 300 includes a first image conversion unit 301a that converts the output data from the first LiDAR 100a into an ambient light image, a second image conversion unit 301b that converts the output data from the second LiDAR 100b into an ambient light image, a third image conversion unit 301c that converts the output data from the third LiDAR 100c into an ambient light image, and a fourth image conversion unit 301d that converts the output data from the fourth LiDAR 100d into an ambient light image. Note that the number of the image conversion units 301 is not limited to four and may be any number as long as the number of the image conversion units 301 is the same as the number of the LiDARs 100.

The input/output processing unit 302 outputs only the ambient light image resulting from converting the output data from the LiDAR 100 selected by the LiDAR selection unit 307 from among the plurality of input ambient light images to the integration unit 303.

The integration unit 303 integrates the RGB image output from the camera 200 with the ambient light image output from the input/output processing unit 302 and outputs the integrated image to the feature extraction unit 304.

The feature extraction unit 304 extracts a feature from the ambient light image integrated with the RGB image. The feature extraction unit 304 can be realized by machine learning, such as DNN (Deep Neural Network), CNN (Convolutional Neural Network), and RF (Random Forest), artificial intelligence, or the like. The feature extraction unit 304 performs feature extraction using a previously learned coefficient. As a learning method for machine learning, a neural network or deep learning is, for example, used. The neural network refers to a model that mimics the human brain's nerve circuits and includes three types of layers, i.e., an input layer, an intermediate layer (hidden layer), and an output layer. Furthermore, the deep learning refers to a model that uses a neural network with a multilayer structure and repeatedly learns features in each layer, thereby making it possible to learn complicated patterns hidden in large amounts of data.

The semantic segmentation processing unit 305 performs semantic segmentation on the basis of the feature output from the feature extraction unit 304. The result of the semantic segmentation is output to a control unit (not shown), which controls the automated driving of the vehicle.

The scene recognition unit 306 recognizes the scene of the surrounding environment on the basis of the output data from the plurality of LiDARs 100 that sense the surrounding environment at different wavelengths. In the present embodiment, the scene recognition unit 306 recognizes the scene of the surrounding environment on the basis of the feature extracted from the image, which is obtained by integrating the ambient light image converted from the output data from the LiDAR 100 with the RGB image. The scene recognition result is output to the LiDAR selection unit 307. The scene recognition unit 306 can be realized by machine learning, such as DNN, CNN, and RF, artificial intelligence, or the like. The scene recognition unit 306 performs scene recognition using the previously learned coefficient.

The LiDAR selection unit 307 selects the LiDAR 100 with a corresponding wavelength for the scene from among the plurality of LiDARs 100 on the basis of the scene recognition result and outputs the selection result to the input/output processing unit 302.

The information processing system 10 and the information processing device 300 are configured as described above. In the present embodiment, the vehicle may have the function of the information processing device 300 in advance, or the processor included in the vehicle may perform the function of the information processing device 300. Alternatively the vehicle having the function of a computer may run a program to realize the information processing device 300 and an information processing method. The program may be installed in advance in the vehicle, or it may be downloaded or distributed in the form of a storage medium or the like, so that the user or the like is allowed to perform installation. Furthermore, the information processing device 300 may be configured as a standalone device.

### [1-2. Processing by Information Processing Device 300]

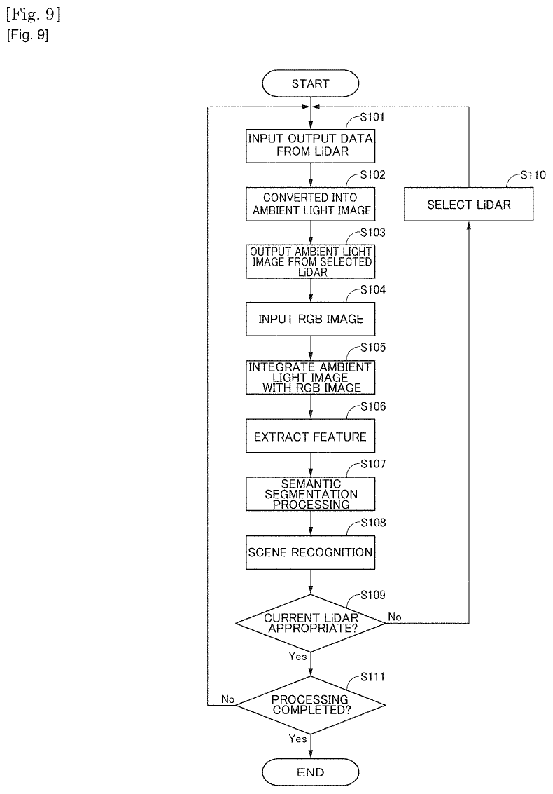

Next, processing by the information processing device 300 will be described with reference to FIG. 9.

First, in step S101, the output data from each LiDAR 100 is input to each image conversion unit 301. As long as the information processing device 300 continues to operate, each LiDAR 100 senses the surrounding environment at a specified cycle in synchronization with the camera 200 using, for example, a synchronization signal, and continues to output the output data.

Next, in step S102, each image conversion unit 301 converts the output data from the LiDAR 100 into an ambient light image.

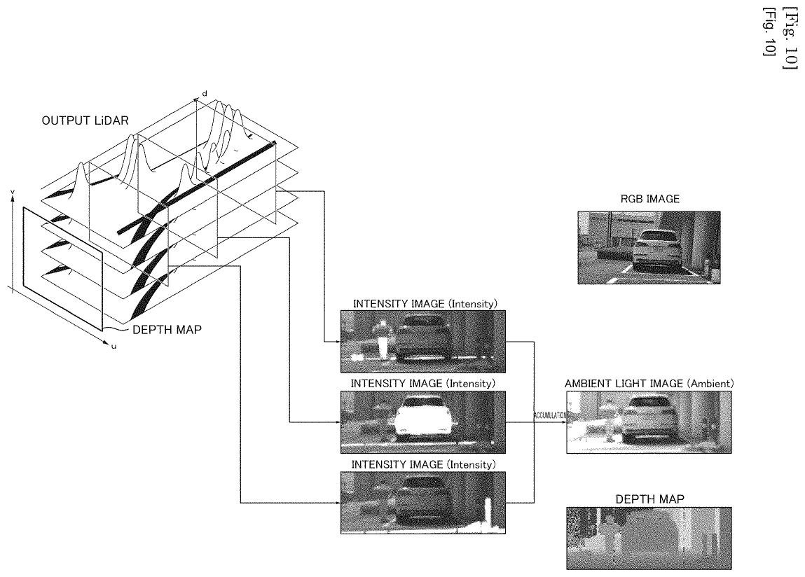

The conversion to the ambient light image can be performed by accumulating a plurality of intensity images (Intensity), which serve as the output data from the LiDAR 100, as shown in FIG. 10. In FIG. 10, the short-distance, medium-distance, and long-distance intensity images included in the output data from the LiDAR 100 are shown for the sake of explanation. However, it is preferable to accumulate all the intensity images included in the output data from the LiDAR 100 in practice.

Next, in step S103, the input/output processing unit 302 outputs the ambient light image to the integration unit 303. Note that before the LiDAR selection unit 307 selects the LiDAR 100, the input/output processing unit 302 outputs the ambient light image, which is output from the image conversion unit 301 corresponding to the LiDAR 100 predetermined by default, to the integration unit 303. The predetermined LiDAR 100 may include a single LiDAR, a plurality of LiDARs, or all the LiDARs. After the LiDAR selection unit 307 performs selection, the input/output processing unit 302 outputs the ambient light image, which is output from the image conversion unit 301 corresponding to the LiDAR 100 selected by the LiDAR selection unit 307, to the integration unit 303.

In step S104, the RGB image output from the camera 200 is input to the integration unit 303. Note that steps S101 to S103 and step S104 do not necessarily need to be performed in this order. Step S104 may be performed prior to or simultaneously with steps S101 to S103. It is sufficient that the ambient light image and the RGB image have been input to the integration unit 303 at the stage when the integration unit 303 integrates the ambient light image with the RGB image. As long as the information processing device 300 continues to operate, the camera 200 senses the surrounding environment in synchronization with the LiDAR 100 using, for example, a synchronization signal, and continues to output the RGB image.

Next, in step S105, the integration unit 303 integrates the ambient light image with the RGB image. Because the ambient light image has low resolution, accuracy in recognizing distant objects, small objects, or the like may be reduced. However, integration with the RGB image having high resolution and a large amount of information can improve the accuracy of semantic segmentation and scene recognition. Furthermore, even when a black-and-white binary image is integrated with the ambient light image instead of the RGB image, the accuracy of semantic segmentation and scene recognition can be improved compared to a case where only the ambient light image is used. However, because the RGB image has a greater amount of information than the black-and-white binary image, it is preferable to use the RGB image to improve their accuracy. The ambient light image integrated with the RGB image is output to the feature extraction unit 304.

Note that when a plurality of LiDARs 100 are selected, a plurality of ambient light images are also output to the integration unit 303. In this case, the integration unit 303 integrates the plurality of ambient light images with the RGB image. When a single LiDAR 100 is selected, the RGB image is integrated with a single ambient light image.

Next, in step S106, the feature extraction unit 304 extracts a feature from the ambient light image integrated with the RGB image and outputs the feature to the semantic segmentation processing unit 305 and the scene recognition unit 306.

Next, in step S107, the semantic segmentation processing unit 305 performs semantic segmentation on the basis of the feature.

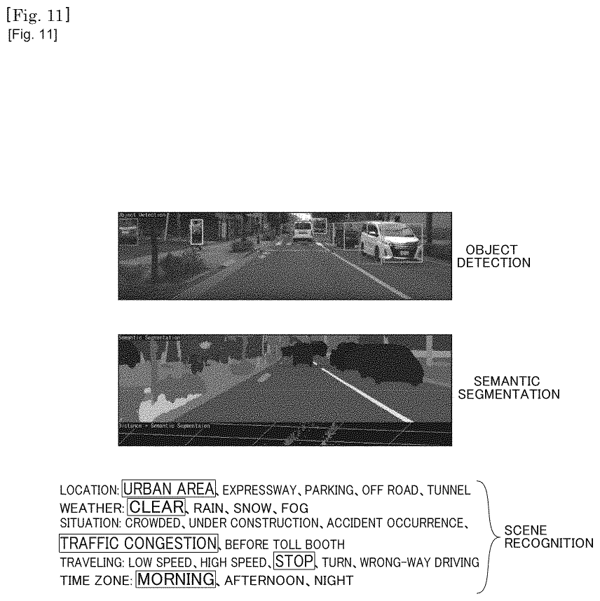

Furthermore, in step S108, the scene recognition unit 306 performs scene recognition on the basis of the feature and outputs a scene recognition result to the LiDAR selection unit 307. As shown in FIG. 11, the scene recognition unit 306 recognizes a scene by dividing the surrounding environment into a plurality of items including location, weather, time zone, situation, traveling speed, and the like. Note that the items of the scene shown in FIG. 11 are merely examples, and the present technology is not limited to these items.

Note that steps S107 and S108 do not necessarily need to be performed in this order. Step S108 may be performed prior to step S107, or it may be performed simultaneously or approximately simultaneously with step S107.

Next, in step S109, the LiDAR selection unit 307 determines whether the currently selected LiDAR 100 is appropriate. A determination as to whether the current LiDAR 100 is appropriate can be made on the basis of objects or the like included in the scene and the corresponding wavelength of the LiDAR 100.

For example, it is assumed that objects or the like included in the scene are wooden posts. The LiDAR 100 that targets wooden posts has a corresponding wavelength of 350 nm to 600 nm. Accordingly, when the currently selected LiDAR 100 has a corresponding wavelength of, for example, 200 nm to 250 nm, it can be determined that the currently selected LiDAR 100 is not appropriate. On the other hand, when the currently selected LiDAR 100 has a corresponding wavelength of 350 nm to 600 nm, it can be determined that the currently selected second LiDAR 100b is appropriate.

When the currently selected LiDAR 100 is not appropriate, the processing proceeds to step S110 (No in step S109).

Next, in step S110, the LiDAR selection unit 307 selects the LiDAR 100 on the basis of the scene recognition result and outputs the selection result to the input/output processing unit 302.

The selection of the LiDAR 100 can be made on the basis of objects or the like included in the scene and the corresponding wavelength of the LiDAR 100. For example, it is assumed that objects or the like included in the recognized scene are water. The LiDAR 100 that targets water has a corresponding wavelength of 1320 nm to 1450 nm. Accordingly the first LiDAR 100a having a corresponding wavelength of 1320 nm to 1450 nm is selected from among the plurality of LiDARs 100 connected to the information processing device 300.

Note that the number of the LiDARs 100 selected by the LiDAR selection unit 307 is not limited to one. For example, it is assumed that objects or the like included in the recognized scene are water and branches. The LiDAR 100 that targets water has a corresponding wavelength of 1320 nm to 1450 nm, and the LiDAR 100 that targets branches has a corresponding wavelength of 350 nm to 600 nm. Accordingly the first LiDAR 100a having a corresponding wavelength of 1320 nm to 1450 nm and the second LiDAR 100b having a corresponding wavelength of 350 nm to 600 nm are selected from among the plurality of LiDARs 100 connected to the information processing device 300.

Then, steps S101 to S109 are performed again. At that time, in step S103, the input/output processing unit 302 outputs the ambient light image resulting from converting the output data from the LiDAR 100 newly selected in step S110 to the integration unit 303.

Then, until the processing is completed in step S111, steps S101 to S111 are repeated to perform semantic segmentation, scene recognition, and the selection of the LiDAR 100.

For example, the first LiDAR 100a and the second LiDAR 100b are selected by default to perform semantic segmentation and scene recognition. When the third LiDAR 100c is selected as a result of the scene recognition, semantic segmentation and scene recognition are performed using only the output data from the third LiDAR 100c.

The processing is completed, for example, when the user turns off the power of the vehicle, turns off the engine of the vehicle, disables the automated driving function, or disables the function of the information processing device 300.

In the manner described above, the processing of the present technology is performed. According to the present technology the LiDAR 100 that performs sensing at an appropriate corresponding wavelength for the scene of the surrounding environment is selected, and semantic segmentation is performed using the output data from the LiDAR 100. Thus, the accuracy of semantic segmentation can be improved. Furthermore, because information that cannot be acquired from the RGB image can be obtained from the output data from the LiDAR 100, the accuracy of semantic segmentation can be improved.

An improvement in the accuracy of semantic segmentation can improve the accuracy of automated driving for the vehicle and realize robust automated driving in various environments.

For example, when the vehicle to which the present technology is applied travels in an urban area with buildings while it is raining, the first LiDAR 100a that targets water and the fourth LiDAR 100d that targets iron are selected, and semantic segmentation is performed using the output data from these LiDARs 100. Then, when the vehicle parks in a parking lot with trees and the rain stops, the second LiDAR 100b that targets wood and the fourth LiDAR 100d that targets iron are selected, and semantic segmentation is performed using the output data from these LiDARs 100.

### 2. Modified Examples

The embodiment of the present technology has been specifically described. However, the present technology is not limited to the above-described embodiment, and various modifications can be made on the basis of the technical concept of the present technology.

The present technology is not limited to vehicles but can be applied to moving bodies of any type, including hybrid electric vehicles, automatic two-wheeled vehicles, bicycles, personal mobility devices, airplanes, drones, ships, robots, construction machines, agricultural machines (tractors), and the like. The present technology can improve the accuracy of automated driving, automatic steering, autonomous movement, and the like for these moving bodies. Moreover, the information processing device 300 may be one that operates on electronic equipment, such as personal computers, smart phones, tablet terminals, or wearable devices. When the information processing device 300 operates on electronic equipment, the electronic equipment may output the results of semantic segmentation to moving bodies.

Furthermore, the present technology is not limited to moving bodies but can be applied to any process that uses the results of semantic segmentation, such as, for example, medical image diagnosis, agriculture, or the cultivation and breeding of animals and plants.

It is also possible to perform feature extraction on the basis of only the ambient light image without integrating an RGB image and then perform semantic segmentation and scene recognition. Accordingly the camera 200 may not be connected to the information processing device 300, and the integration unit 303 is not an essential configuration of the information processing device 300. However, the integration of the ambient light image with the RGB image leads to an increased amount of information and can improve the accuracy of semantic segmentation and scene recognition.

The present technology can also be applied to an embodiment in which a plurality of sensors other than the LiDARs 100 are connected to the information processing device 300 and a sensor that is appropriate for performing a specified process is selected from among the plurality of sensors. Examples of sensors other than the LiDARs 100 include cameras, infrared sensors, thermal cameras, and the like.

In the embodiment, it is described that the input/output processing unit 302 outputs the ambient light image resulting from converting the output data from the LiDAR 100 selected by the LiDAR selection unit 307 to the integration unit 303. However, only the LiDAR 100 selected by the LiDAR selection unit 307 from among the plurality of LiDARs 100 may output the output data, or only the image conversion unit 301 corresponding to the LiDAR 100 selected by the LiDAR selection unit 307 may output the ambient light image. In any case, the output data from the LiDAR 100 selected by the LiDAR selection unit 307 is used for semantic segmentation and scene recognition. In this case, it is necessary to output the selection result of the LiDAR selection unit 307 to each LiDAR 100 or to each image conversion unit 301.

The present technique can also employ the following configurations.

(1)

An information processing device including:
a scene recognition unit that recognizes a scene of a surrounding environment on a basis of output data from a plurality of LiDARs that sense the surrounding environment at different wavelengths; and
a LiDAR selection unit that selects one or a plurality of LiDARs, whose output data is used for semantic segmentation, from among the plurality of LiDARs on a basis of a scene recognition result.
   (2)

The information processing device according to (1), wherein the plurality of LiDARs are adjusted in advance to perform sensing at different wavelengths corresponding to types of a target.

(3)

The information processing device according to (1) or (2), including an image conversion unit that converts output data from the LiDAR into an ambient light image.

(4)

The information processing device according to (3), including an integration unit that integrates the ambient light image with a camera image.

(5)

The information processing device according to (4), wherein the camera image is an RGB image.

(6)

The information processing device according to (3), including a feature extraction unit that extracts a feature from the ambient light image.

(7)

The information processing device according to (6), including a semantic segmentation processing unit that performs semantic segmentation on a basis of the feature.

(8)

The information processing device according to (7), wherein the semantic segmentation processing unit performs semantic segmentation on a basis of the feature extracted from the ambient light image, the ambient light image resulting from converting output data from the LiDAR selected by the LiDAR selection unit.

(9)

The information processing device according to any of (1) to (8), wherein the scene recognition unit recognizes the scene of the surrounding environment on the basis of the feature.

(10)

An information processing method including:
recognizing a scene of a surrounding environment on a basis of output data from a plurality of LiDARs that sense the surrounding environment at different wavelengths; and
selecting one or a plurality of LiDARs, whose output data is used for semantic segmentation, from among the plurality of LiDARs on a basis of a scene recognition result.
   (11)

A program causing a computer to perform an information processing method including:
recognizing a scene of a surrounding environment on a basis of output data from a plurality of LiDARs that sense the surrounding environment at different wavelengths; and
selecting one or a plurality of LiDARs, whose output data is used for semantic segmentation, from among the plurality of LiDARs on a basis of a scene recognition result.

### REFERENCE SIGNS LIST

100 LiDAR
300 Information processing device
301 Image conversion unit
303 Integration processing unit
304 Feature extraction unit
305 Semantic segmentation processing unit
306 Scene recognition unit
307 LiDAR selection unit

1. An information processing device comprising:
a scene recognition unit that recognizes a scene of a surrounding environment on a basis of output data from a plurality of LiDARs that sense the surrounding environment at different wavelengths; and
a LiDAR selection unit that selects one or a plurality of LiDARs, whose output data is used for semantic segmentation, from among the plurality of LiDARs on a basis of a scene recognition result.

2. The information processing device according to claim 1, wherein the plurality of LiDARs are adjusted in advance to perform sensing at different wavelengths corresponding to types of a target.

3. The information processing device according to claim 1, comprising an image conversion unit that converts output data from the LiDAR into an ambient light image.

4. The information processing device according to claim 3, comprising an integration unit that integrates the ambient light image with a camera image.

5. The information processing device according to claim 4, wherein the camera image is an RGB image.

6. The information processing device according to claim 3, comprising a feature extraction unit that extracts a feature from the ambient light image.

7. The information processing device according to claim 6, comprising a semantic segmentation processing unit that performs semantic segmentation on a basis of the feature.

8. The information processing device according to claim 7, wherein the semantic segmentation processing unit performs semantic segmentation on a basis of the feature extracted from the ambient light image, the ambient light image resulting from converting output data from the LiDAR selected by the LiDAR selection unit.

9. The information processing device according to claim 1, wherein the scene recognition unit recognizes the scene of the surrounding environment on the basis of the feature.

10. An information processing method comprising:
recognizing a scene of a surrounding environment on a basis of output data from a plurality of LiDARs that sense the surrounding environment at different wavelengths; and
selecting one or a plurality of LiDARs, whose output data is used for semantic segmentation, from among the plurality of LiDARs on a basis of a scene recognition result.

11. A program causing a computer to perform an information processing method including:
recognizing a scene of a surrounding environment on a basis of output data from a plurality of LiDARs that sense the surrounding environment at different wavelengths; and
selecting one or a plurality of LiDARs, whose output data is used for semantic segmentation, from among the plurality of LiDARs on a basis of a scene recognition result.
